(19) United States
(12) Patent Application Publication
(10) Pub. No.: US 2007/0103535 A1
(43) Pub. Date: May 10, 2007

(54) Image forming apparatus

(75) Inventor: Eiichi Kito, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation

(21) Appl. No.: 11/592,198

(22) Filed: Nov. 3, 2006

(30) Foreign Application Priority Data
Nov. 4, 2005 (JP) 2005-321062

(51) Int. Cl. B41J 2/01

(52) U.S. Cl. 347/104

(57) ABSTRACT

The image forming apparatus includes a loading section for loading a recording medium, an image recording section for recording an image on the recording medium, and a transporting system for transporting the recording medium to the image recording section. The loading section is provided with a cassette holder block for holding a bottom of a cassette containing the recording medium in the form of a pile of cut sheets, and a magazine receiver formed in the cassette holder block as a recess in which a magazine containing the recording medium in a form of a roll of continuous recording medium is to be inserted.

The entire contents of the documents cited in this specification are herein incorporated by reference.

### BACKGROUND OF THE INVENTION

This invention belongs to a technical field of image forming apparatus such as ink-jet printers and electrophotographic printers, and relates particularly to image forming apparatus of a reduced size to which sheet-type recording media and roll-type recording media are both usable.

Prints of the images taken on a photographic film or with a digital camera are generally made by a photographic printer intended for commercial use such as a so-called minilab, whereupon printing paper (photosensitive material for silver halide photography) is exposed to light so as to project an image onto it (that is to say, an image is printed on printing paper), the exposed printing paper being subjected to wet processing involving the steps of development, bleaching, fixing and washing, and then dried to output it as a finished print.

Photographic printers using printing paper require troublesome maintenance and liquid waste disposal due to the wet-type processing. For these and other reasons, image forming apparatus capable of outputting a print with the quality of a photographic image (or photograph) by an ink-jet or electrophotographic method are coming into commercial uses.

Recording media for various image forming apparatus fall into two categories: sheet-type recording media in cut-sheet form which are generally used in at-home printers, and roll-type recording media in the form of a roll of continuous medium such as used in the ink-jet printer described in JP 2003-212402 A.

Generally speaking, roll-type recording media are less expensive while sheet-type ones have an advantage in allowing easier making of various prints differing in size or form.

It is therefore preferable in the case of commercial image forming apparatus and so forth to use a roll-type recording medium for the making of prints of an ordinary size which are to be made in huge amounts, and use a sheet-type recording medium for the making of prints having a postcard size or large-format size which will be made in small amounts.

In recent years, images are increasingly handled as digital data owing to the popularization of digital cameras and personal computers, which is bringing about processing of images in different situations to make a variety of prints. As a consequence, it is being required that both the large-scale processing at a low cost and the making of prints with diversified sizes be carried out by a single image forming apparatus. In other words, it is preferred that a sheet-type recording medium and a roll-type recording medium can be used in one and the same image forming apparatus.

On the other hand, image forming apparatus are preferably compact and of simple structure in terms of their setting in such places as the interior of a convenience store.

In this connection, a recording medium is charged (fed) into an image forming apparatus generally by loading a box-shaped case containing the medium in a predetermined loading position, with the case being either that called cassette and containing a sheet-type recording medium as a pile of cut sheets, or that called magazine and containing a roll-type recording medium as a rotatable roll.

### SUMMARY OF THE INVENTION

The requirement as above cannot be filled by a printer in which roll-type recording media are exclusively used, such as described in JP 2003-212402 A, or a printer in which sheet-type recording media are exclusively used, such as intended for home use.

Image forming apparatus in which both the sheet-type recording media and roll-type recording media can be used are known indeed, including the ink-jet printer described in JP 2000-127357 A. Such an apparatus, however, should have a more complicated structure and a larger size because it requires two positions for the loading of a recording medium case, one dedicated to the cassette containing a sheet-type recording medium and the other dedicated to the magazine containing a roll-type recording medium.

An object of the present invention is to solve the above problems with the art and provide an image forming apparatus to which sheet-type recording media in cut-sheet form and roll-type recording media in the form of a roll of continuous medium are both usable and, moreover, which is compact.

The above object is achieved by providing according to the present invention an image forming apparatus comprising: a loading section for loading a recording medium; an image recording section for recording an image on the recording medium; and a transporting system for transporting the recording medium to the image recording section, wherein the loading section is provided with a cassette holder block for holding a bottom of a cassette containing the recording medium in a form of a pile of cut sheets, and a magazine receiver formed in the cassette holder block as a recess in which a magazine containing the recording medium in a form of a roll of continuous recording medium is to be inserted.

In the image forming apparatus of the present invention as above, the loading section preferably has a detection device for determining whether the cassette or the magazine is loaded, and a control unit for controlling recording medium delivery in accordance with a detection result obtained by the detection device.

It is preferable that the roll of the continuous recording medium is contained in the magazine as being accompanied by disc-shaped members on both sides in a direction in which a roll shaft of the roll extends, and the loading section has a rotary shaft provided above the cassette holder block; a sheet delivering roller which abuts an uppermost sheet of the recording medium in the form of the pile of cut sheets in the cassette and is mounted on the rotary shaft; and disc rotating rollers which rotate the disc-shaped members in the magazine and are mounted on the rotary shaft at both sides of the sheet delivering roller, and that, when the cassette is loaded in the loading section, a sheet of the recording medium in a form of cut sheet is delivered from the cassette by the sheet delivering roller, and when the magazine is loaded in the loading section, the continuous recording medium in the form of the roll is delivered from the magazine by rotating the roll of the continuous recording medium by means of the disc rotating rollers.

It is also preferable that the loading section has: a cut-paper delivery unit for delivering a sheet of the recording medium in a form of cut sheet from the cassette; a rolled-paper delivery unit for delivering the continuous recording medium in the form of the roll from the magazine; a driving source for driving the cut-paper delivery unit and the rolled-paper delivery unit; a first transmission unit which includes a first clutch and transmits driving force of the driving source to the cut-paper delivery unit; and a second transmission unit which includes a second clutch and transmits the driving force of the driving source to the rolled-paper delivery unit.

Preferably, the cassette holder block has an extendable mechanism, and the cassette holder block is extendable in a direction in which a roll shaft of the roll of the continuous recording medium loaded in the loading section extends so that the cassette holder block and the magazine receiver are variable in size in the direction in which the roll shaft extends. In addition, the image forming apparatus of the present invention preferably comprises a regulation member for regulating the cassette held by the cassette holder block in position, with the regulation member being variable in position in itself.

It is also preferable that the roll of the continuous recording medium is contained in the magazine as being accompanied by disc-shaped members on both sides in a direction in which a roll shaft of the roll extends, and the loading section has: a rotary shaft provided above the cassette holder block; and plural pairs of disc rotating rollers mounted on the rotary shaft, each pair of disc rotating rollers rotating a pair of the disc-shaped members corresponding to each of plural rolls of the continuous recording medium with different widths in the magazine, and that the continuous recording medium in the form of the roll is delivered from the magazine by rotating the roll of the continuous recording medium by means of corresponding pair of the disc rotating rollers.

According to the present invention with the configuration as described above, the cassette containing a sheet-type recording medium in cut-sheet form and the magazine containing a roll-type recording medium in the form of a roll of continuous medium can be loaded in one and the same loading position. In other words, a sheet-type recording medium and a roll-type recording medium can be used in the same compact apparatus having no loading position dedicated to the cassette or magazine.

### BRIEF DESCRIPTION OF THE DRAWINGS

In the accompanying drawings:

FIG. 1A is a schematic diagram showing an embodiment of the image forming apparatus according to the present invention;

FIG. 1B is a schematic diagram showing a different loading state of the loading section of the image forming apparatus as shown in FIG. 1A;

FIG. 2A is a cross-sectional view of the loading section as shown in FIG. 1A;

FIG. 2B is a cross-sectional view of the loading section as shown in FIG. 1B;

FIG. 3 is a cross-sectional view of the loading section of the image forming apparatus according to the present invention, in the loading section, another embodiment of the magazine being loaded;

FIGS. 4A and 4B are cross-sectional views showing different loading states of another embodiment of the loading section of the image forming apparatus according to the present invention, repectively; and

FIG. 5 is a cross-sectional view of yet another embodiment of the loading section of the image forming apparatus according to the present invention.

### DETAILED DESCRIPTION OF THE INVENTION

The image forming apparatus according to the present invention is now described in detail with reference to the preferred embodiments as shown in the accompanying drawings.

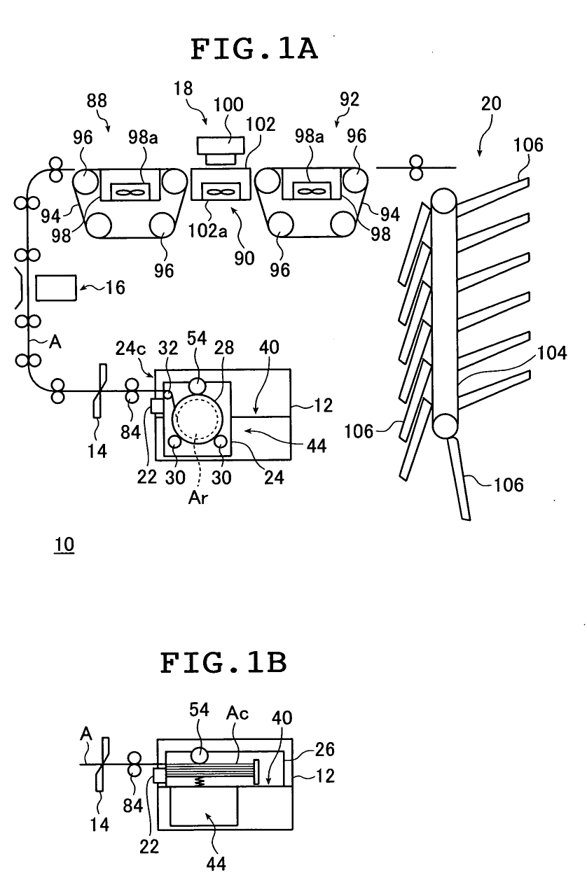

FIG. 1A schematically shows a printer 10 as an embodiment of the image forming apparatus according to the present invention.

The printer 10 is adapted to record an image on recording paper A (as a recording medium) by an ink-jet method so as to output the image as a print, and comprises a loading section 12, a cutter 14, a back-printing unit 16, an image recording section 18, and a discharging section 20.

It should be understood that the printer 10 may have any of various members of the conventional printer, such as a transporting roller pair, a guide roller, a guide member, and a sensor for detecting the recording paper A, as required in addition to the shown members.

In the loading section 12, a magazine 24 containing roll-type recording paper Ar in the form of a roll of continuous recording paper or web-type recording paper (also referred to as rolled paper Ar) and a cassette 26 containing sheet-type recording paper Ac in the form of a pile of cut sheets (also referred to as a cut paper or papers Ac) are loaded.

The loading section 12 in FIG. 1A is in a state to have the magazine 24 loaded therein. The loading section 12 in a state to have the cassette 26 loaded therein is schematically shown in FIG. 1B.

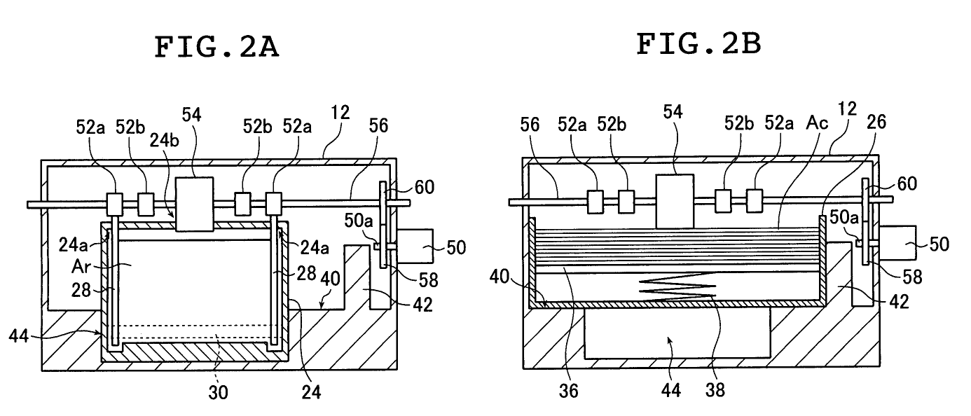

FIGS. 2A and 2B each show schematically a cross section of the loading section 12 across the recording paper transporting direction (delivering direction) as seen from the rear side (toward a drawing-out port 24c of the magazine 24). The loading section 12 is in a state to have the magazine 24 loaded therein in FIG. 2A, and in a state to have the cassette 26 loaded therein in FIG. 2B.

The magazine 24 is a rectangular solid-shaped case in which the rolled paper Ar is to be contained.

In the example as shown in FIGS. 1A and 2A, the recording paper Ar is contained in the magazine 24 as being rolled (wound) on a roll shaft and accompanied by disc-shaped members 28 on both sides in the direction in which the roll shaft extends (direction orthogonal to the recording paper delivering (transporting) direction; hereafter referred to as the width direction). The rolled paper Ar is thus sandwiched between the disc-shaped members 28 by, for instance, providing a projection in the center of each disc-shaped member 28 and inserting the projection into a center hole of each end of rolled paper Ar or either end of the roll shaft on which the web-type paper Ar is rolled.

Below in the magazine 24, two support rollers 30 are rotatably arranged. The support rollers 30 extend in the width direction and are spaced apart from each other in the recording paper delivering direction (hereafter referred to as the transporting direction).

In the shown example, the rolled paper Ar is contained in the magazine 24 by resting the disc-shaped members 28 having the rolled paper Ar sandwiched between them on the support rollers 30. Since the support rollers 30 extend in the width direction and are axially supported to be rotatable as mentioned above, the disc-shaped members 28 and, accordingly, the rolled paper Ar contained in the magazine 24 are rotatable in the transporting direction.

The magazine 24 and the disc-shaped members 28 are so dimensioned that upper parts of the members 28 rested on the support rollers 30 may protrude from the top of the magazine 24. In order to realize such a configuration, slits 24a extending in the transporting direction to allow the penetration or protrusion of the disc-shaped members 28 are formed in the top of the magazine 24 in the positions determined in accordance with the size in the width direction of the roll of the rolled paper Ar to be contained. In the shown example, two slits 24a (as a pair) are formed symmetrically with respect to the center as defined in the width direction because the rolled paper Ar is sandwiched between two disc-shaped members 28 aligned in the width direction as described above.

In the shown example, the magazine 24 is also provided in its top with an opening 24b through which a sheet delivering roller 54 to be described later is inserted.

In addition, the magazine 24 has the drawing-out port 24c in the form of a slit through which the recording paper Ar is delivered. In the vicinity of the drawing-out port 24c, a guide roller 32 is placed which guides the recording paper Ar as unwound toward the drawing-out port 24c.

When unwound, the recording paper Ar is drawn out such that it comes off the roll in the underpart thereof and moves upward to the guide roller 32. Then, as being guided by the guide roller 32, the recording paper Ar is drawn or pulled out of the magazine 24 through the drawing-out port 24c.

The cassette 26 is a case in the form of a rectangular solid whose one face (top face) is open, and contains the cut papers Ac as a pile of cut sheets, as shown in FIGS. 1B and 2B.

The cassette 26 has a table 36 on which the cut papers Ac are to be set as a pile of cut sheets. The table 36 is urged by a biasing member 38, a spring for instance, upward (toward the open face of the cassette 26). Consequently, the cut paper or papers Ac contained in the cassette 26 are also urged upward.

The biasing member 38 urges the table 36 so that the cut paper or papers Ac may adequately be caused to abut or press against the sheet delivering roller 54 to be described later not only when the cassette 26 loaded in the loading section 12 contains the maximum number of cut sheets of the cut papers Ac but when only one sheet of the cut paper Ac remains in the cassette 26.

The loading section 12 has a cassette holder block 40 formed therein which so holds the bottom of the cassette 26 rested on it that the cassette 26 may be loaded in the predetermined position. The cassette holder block 40 is provided with an upright wall 42 as a positioning member used for loading the cassette 26 in the predetermined position.

In the cassette holder block 40, moreover, a magazine receiver 44 is formed as a recess having an opening of almost the same dimension as the bottom of the magazine 24. In the shown example, the magazine 24 or rolled paper Ar contained therein is loaded in the predetermined position in the loading section 12 (of the printer 10) by inserting the magazine 24 into the magazine receiver 44.

As described before, it is required recently that prints of various sizes be made by a single printer (image forming apparatus). In view of this, it is preferred in a commercial image forming apparatus to use rolled paper (roll-type recording paper) of a reduced cost for the making of prints of an ordinary size which are chiefly to be made and, in the case of making prints having a special size such as a large-format size, use cut papers (sheet-type recording papers) which are readily prepared as cut sheets varying in size. If, however, such two types of recording paper are intended for use in combination in the conventional printer, the printer needs a loading section for the magazine containing rolled paper and that for the cassette containing cut papers, leading to increase in production costs and size as well of the apparatus.

It is quite different for the printer 10 of the present invention, in which the holder block (loading section) for the cassette containing cut papers Ac is provided with a recess in which the magazine containing rolled paper Ar is inserted or loaded. In other words, according to the present invention, the magazine and the cassette can be loaded in the same loading section, which enables the combined use of rolled paper Ar and cut papers Ac in a compact printer of a simple structure.

In the loading section 12 of the printer 10 as shown, a motor 50 is provided which serves as a driving power source for the recording paper delivery, and a rotary shaft 56 is axially supported to be rotatable, on which shaft disc rotating rollers 52a and 52b for rotating the disc-shaped members as described above, and the sheet delivering roller 54 as well, are mounted.

A gear 58 is fixed to a rotor shaft 50a of the motor 50 on one hand and a gear 60 to the rotary shaft 56 on the other, with the gears 58 and 60 being engaged with each other. In consequence, the rotary shaft 56 and, as a matter of course, the disc rotating rollers 52a and 52b as well as the sheet delivering roller 54 mounted thereon are rotated when the motor 50 runs.

The disc rotating rollers 52a and 52b are rollers elastic to some extent, such as rubber rollers, and each of two pairs of rollers 52a and 52b are arranged in the positions which are determined in accordance with the size in the width direction of the relevant roll of the rolled paper Ar, and symmetrically with respect to the center as defined in the width direction (positions corresponding to the slits 24a as described above in the case of the pair of rollers 52a). In the shown example, the disc rotating rollers 52a are adapted for the rolled paper Ar of a larger width (size).

The disc rotating rollers 52a and 52b have such a diameter as allowing them to press against the disc-shaped members 28 protruding with the upper parts thereof from the magazine 24 so as to exert certain pressure on the members 28 when the magazine 24 is loaded in the loading section 12.

The sheet delivering roller 54 is made of a material having an adequate frictional force such as rubber, and is located in the recording paper transporting plane in the center of recording paper as defined in the width direction.

The diameter of the sheet delivering roller 54 is such that the roller 54 does not come into contact with the rolled paper Ar in the magazine 24 loaded, even if the roll of the rolled paper Ar has the maximum diameter correspondingly.

As described before, the rolled paper Ar is contained in the magazine 24 as being sandwiched between the disc-shaped members 28, whereupon the members 28 (and the rolled paper Ar) are rotatably supported by the support rollers 30. Accordingly, the recording paper Ar can be delivered from the magazine 24 loaded in the loading section 12 by rotating the rotary shaft 56 or disc rotating rollers 52a and 52b mounted thereon and thereby rotating the roll of the rolled paper Ar.

The cut papers Ac are contained in the cassette 26 as a pile of cut sheets and urged by the biasing member 38 from below. When the cassette 26 is loaded in the loading section 12, the uppermost sheet of cut paper Ac is caused to abut or press against the sheet delivering roller 54. Accordingly, the cut sheets of recording paper Ac can be delivered from the cassette 26 loaded in the loading section 12 by rotating the rotary shaft 56 or sheet delivering roller 54 mounted thereon.

In other words, according to the configuration of the shown example in which the disc rotating rollers 52a and 52b as well as the sheet delivering roller 54 are mounted on a single rotary shaft, both the rolled paper Ar and the cut paper Ac can be delivered from the loading section 12 by a simple driving mechanism including the sole motor 50.

As shown in FIGS. 1A and 1B, the loading section 12 has a detection means 22.

The detection means 22 is used to determine whether the magazine 24 or the cassette 26 is loaded in the loading section 12. In accordance with the detection result, running of the motor 50 and other factors in the control of delivery of recording paper (rolled paper Ar or cut paper Ac) from the loading section 12 (magazine 24 or cassette 26) are selected in the loading section 12.

The detection means 22 is not particularly limited, and any of those used in a variety of printers and so forth for the determination of recording paper type, for instance, may be employed.

In an exemplary detection means, barcords and a barcord reader are utilized. It is also possible to provide on each of the magazine 24 and the cassette 26 projections which are specific in position, number, shape or the like to the relevant magazine or cassette, and detect the projections with a sensor and so forth.

The magazine 24 as shown in FIG. 2A is suited to only one width of the rolled paper Ar, and provided in its top with a pair of (namely, two) slits 24a for allowing the protrusion of the disc-shaped members 28. The present invention, however, is in no way limited to this configuration.

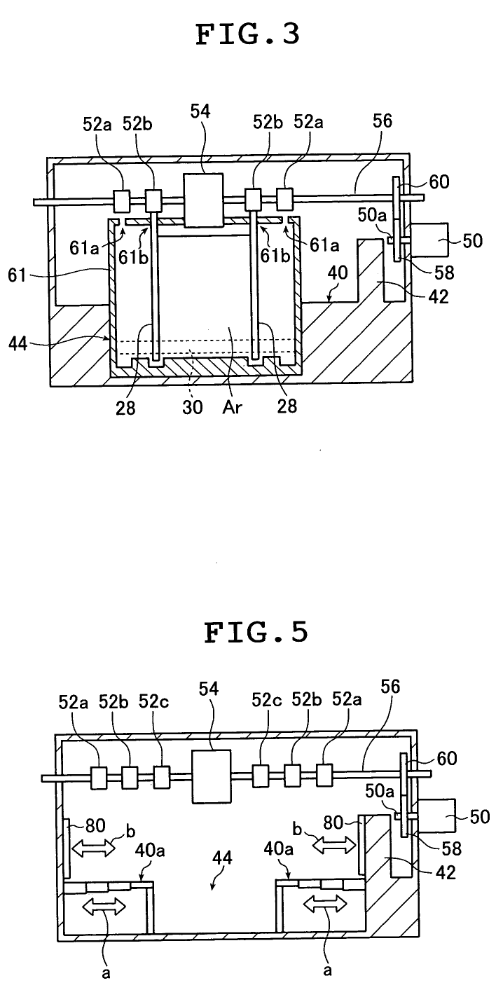

The magazine of the present invention may be adapted to two widths of the rolled paper Ar as is the case with a magazine 61 shown in FIG. 3 which is provided with two pairs of (namely, four) slits 61a and 61b, with each pair being symmetrical with respect to the center as defined in the width direction. It is also possible that the magazine is adapted to three or more widths of the rolled paper Ar, and provided with three or more pairs of slits.

With such configurations, adaptation to multiple widths of the rolled paper Ar can be achieved under a simple structure, which in turn leads to limited magazine variations.

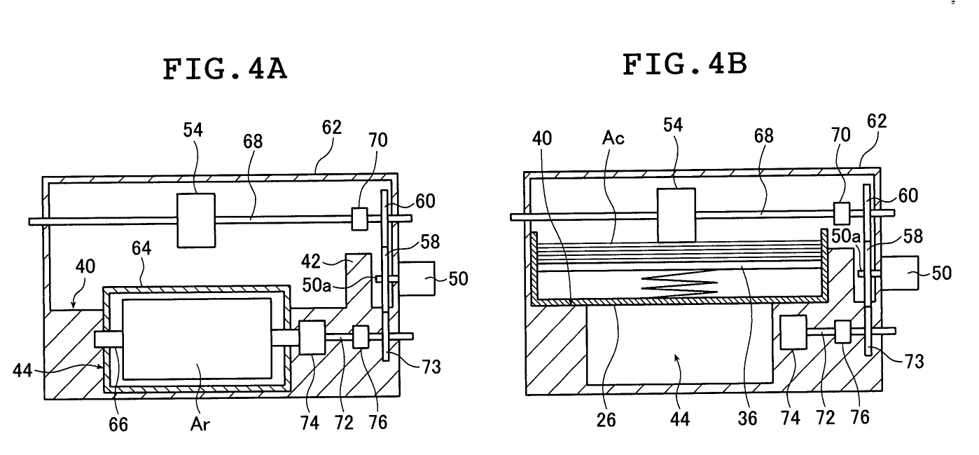

FIGS. 4A and 4B illustrate another example of the loading section of the present invention. In the loading section as shown, a corresponding magazine is loaded in FIG. 4A, and a cassette 26 in FIG. 4B.

The loading section as shown in FIGS. 4A and 4B is identical to the loading section 12 of FIGS. 2A and 2B in many elements, so that like reference characters are imparted to such elements, on which description will not be repeated in general. The cassette 26 as shown in FIG. 4B is identical to that of FIGS. 1B and 2B.

As seen from FIG. 4A, a magazine 64 loaded in a loading section 62 as shown in FIGS. 4A and 4B contains rolled paper Ar which is not sandwiched between such members as the disc-shaped members 28 but remains simply rolled on a roll shaft 66.

The magazine 64 axially supports the roll shaft 66 to be rotatable, while allowing its protrusion from the magazine itself in the width direction, so that the rolled paper Ar is rotatable in the magazine 64.

In the loading section 62, a rotary shaft 68 is axially supported to be rotatable. The rotary shaft 68 has no such rollers as the disc rotating rollers 52a or 52b but only a sheet delivering roller 54 fixed thereto.

Similar to the previous example, a gear 60 is fixed to the rotary shaft 68, and the gear 60 is engaged with a gear 58 of a motor 50. The rotary shaft 68 is provided with a clutch 70 with which transmission of the rotating power of the motor 50 to the sheet delivering roller 54 is made effective or not at will.

Also in the loading section 62, a rotary shaft 72 is axially supported to be rotatable in the position where the shaft 72 is in alignment with the roll shaft 66 of the rolled paper Ar contained in the magazine 64 and loaded as such in the loading section 62.

The rotary shaft 72 has a gear 73 fixed thereto and engaged with the gear 58 of the motor 50. At the end of the rotary shaft 72 opposite from the gear 73, a coupler 74 is arranged which is connected with the roll shaft 66 of the rolled paper Ar so as to rotate the roll shaft 66 through the rotation of the shaft 72. The rotary shaft 72 is further provided with a clutch 76 with which transmission of the rotating power of the motor 50 to the coupler 74 is made effective or not at will.

Thus in the loading section 62 as shown in FIGS. 4A and 4B, delivery of recording paper can be carried out as follows: When the magazine 64 is loaded in a magazine receiver 44, the recording paper Ar is delivered from the magazine 64 by connecting the coupler 74 with the roll shaft 66, throwing in the clutch 76 and throwing out the clutch 70, and then driving the motor 50 so as to rotate the roll of the rolled paper Ar.

When the cassette 26 is loaded on a cassette holder block 40, the cut paper Ac is delivered from the cassette 26 similarly to the example shown in FIGS. 1B and 2B by throwing in the clutch 70 and throwing out the clutch 76, and then driving the motor 50.

In the examples as described above, the magazine receiver 44 and the cassette holder block 40 each have a fixed size, although, according to the present invention, both may be adjustable in size.

As an example, a cassette holder block 40a as shown in FIG. 5 is of a nested structure and extendable in the width direction as indicated by arrows a, that is to say, the cassette holder block 40a and the magazine receiver 44 are variable in size (the magazine receiver 44 being smaller as the cassette holder block 40a is larger, naturally) and, accordingly, the magazine (24; See FIG. 1A) and cassette (26; See FIG. 1B) to be loaded can have a variety of sizes.

In that case, disc rotating rollers are provided depending on the magazines (24) of different sizes that can be loaded. In the example as shown in FIG. 5, three pairs of disc rotating rollers 52a, 52b and 52c are provided corresponding to three widths of the rolls of the rolled paper Ar contained in different magazines (24).

In the shown example, it is preferred that a plurality of guide plates 80 different in thickness be prepared beforehand, and the loaded cassette (26) be appropriately regulated in position in the width direction as indicated by arrows b by arranging the guide plates having thicknesses suitable for the size of the cassette (26) in such a manner as shown in FIG. 5.

The cassette (26) may also be regulated appropriately in position in the width direction by using a wall 42 which is of a nested structure similar to the cassette holder block 40a and extendable in the width direction, or again, by using extendable guide plates of a nested structure.

The printer 10 (image forming apparatus) according to the present invention may be adapted for a so-called multiple line transporting method. In that case, the recording paper A is prepared as a plurality of sheets set in a row in the width direction, and the sheets of paper A are fed as such to the image recording section 18 and subjected to image recording so as to improve productivity.

In order to allow multiple line transportation of recording paper, a plurality of such loading sections as shown in FIGS. 2A, 2B, 3, 4A, 4B and 5 may be provided as being set in a row in the width direction. The loading sections employed may be the same or different from one another.

The recording paper delivered from the loading section 12 (magazine 24 or cassette 26) is transported by a drawing-out roller pair 84 to the cutter 14. The cutter 14 is used when the magazine 24 is loaded in the loading section 12, to be more specific, used to cut the continuous recording paper Ar into sheets having sizes corresponding to those of desired prints. The cutter 14 is a conventional guillotine cutter, for instance.

With the magazine 24 being loaded in the loading section 12, delivering of the recording paper Ar from the loading section 12 and transporting of the recording paper Ar by the drawing-out roller pair 84 are stopped at the time the length of the recording paper Ar downstream from the cutter 14 has met a desired print size. The cutter 14 is then actuated to cut the recording paper Ar (rolled paper Ar), and a sheet of recording paper having a size identical to a desired print size, which is herein referred to as sheet of recording paper A, is thus obtained. Naturally, the cutter 14 is not actuated when the cassette 26 is loaded in the loading section 12.

The sheet of recording paper A is transported from the cutter 14 to the back-printing unit 16.

In the back-printing unit 16, back printing (recording of back prints) is performed on the back side (side on which no images are recorded) of the sheet of recording paper A using, for instance, an impact dot matrix printer. Alternatively, an ink-jet printer or thermal printer may be used for back printing.

The contents of back printing are not particularly limited, and their examples include various such pieces of information as standardized in the field of photoprinting.

The sheet of recording paper A bearing the back prints recorded in the back-printing unit 16 is then transported to the image recording section 18.

The image recording section 18 is adapted to perform image recording (image forming) on the sheet of recording paper A by ink-jet printing, and comprises a transporting system 88 which is located on the upstream side in the section 18, a recording unit 90, and a transporting system 92 which is located on the downstream side in the section 18.

The transporting system 88 on the upstream side transports the sheet of recording paper A to the recording unit 90, and further transports the sheet for scanning when it is subjected to the image recording by the recording unit 90.

The transporting system 92 on the downstream side transports the sheet of recording paper A for scanning when it is subjected to the image recording by the recording unit 90, and transports the sheet of recording paper A bearing the image recorded by the recording unit 90 (namely, the print thus made) to the discharging section 20.

The transporting system 88 and the transporting system 92 are the same in configuration.

Each system is constructed by a belt conveyer which is composed of an endless belt 94 with a large number of through holes and four rollers 96 about which the belt 94 rotates; and a support 98 which is so arranged up inside the loop of the belt conveyer (endless belt 94) that it abuts in place on the inner surface of the endless belt 94.

The support 98 has a hollow body whose top is provided with a large number of through holes, and a suction means 98a such as a fan is arranged in its interior. Consequently, the sheet of recording paper A can be attracted by suction and brought into moderate contact with the support 98 or rather the endless belt 94 by driving the suction means 98a.

The sheet of recording paper A transported to either of the transporting systems 88 and 92 is then transported by the belt conveyer composed of the endless belt 94 and the rollers 96 while brought into moderate contact with the endless belt 94 by driving the suction means 98a.

Owing to such a configuration, the transporting systems 88 and 92 located on the upstream and downstream sides, respectively, can feed the sheet of recording paper A to the recording unit 90 and further transporte the sheet for scanning while surely preventing the lifting of the sheet due to curling and so forth. Moreover, the transporting system 92 on the downstream side can transport the sheet of recording paper A after image recording to the discharging section 20 without coming into contact with the sheet surface bearing the image recorded.

As seen from the above, the recording unit 90 is located between the transporting systems 88 and 92.

The recording unit 90 includes a conventional recording means 100 of an ink-jet type using an ink-jet recording head (hereafter referred to simply as recording head) and a reference guide 102 for regulating the sheet of recording paper A in position in the vertical direction, and is adapted to record full-color images by a conventional ink-jet recording method.

The method of image recording (image forming) by the recording means 100 is not particularly limited, and any method employed in conventional ink-jet printers is usable.

Thus, the recording means 100 may record images by a so-called full width array method (FWA method) in which a line head provided with a raw of nozzles (nozzles for ejecting ink droplets) is used, with the nozzle raw having a length exceeding the maximum width of the sheet of recording paper A, and image recording is carried out by arranging or fixing the line head so that the nozzle raw may extend in the width direction, and transporting (for scanning) the sheet of recording paper A continuously. Alternatively, the method of image recording by the recording means 100 may be a so-called partial width array method (PWA method) in which a small recording head is so mounted on a carriage (scanning means) that its nozzle raw may extend parallel to the direction in which the sheet of recording paper A is transported, and image recording is carried out by transporting the sheet of recording paper A intermittently and moving the recording head for scanning in the width direction when the transportation of the sheet of recording paper A is stopped.

In this regard, the transporting systems 88 and 92 located on the upstream and downstream sides, respectively, will transport the sheet of recording paper A continuously in the case of the recording means 100 recording images by a FWA method, and intermittently in the case of the recording means 100 recording images by a PWA method.

The reference guide 102 supports the sheet of recording paper A from below to regulate it in position in the vertical direction (direction in which ink droplets are ejected) as predetermined (that is to say, make the distance between the recording head and the sheet of recording paper A as predetermined).

Similar to the support 98, the reference guide 102 has a hollow body whose top is provided with a large number of through holes, and a suction means 102a such as a fan is arranged in its interior. Consequently, the reference guide 102 can regulate the sheet of recording paper A in position in a specified direction while attracting the sheet by suction to a state of moderate contact with the reference guide 102 itself so as to prevent the sheet from lifting due to curling and so forth.

The measures for preventing the sheet of recording paper A from lifting off the reference guide 102 is not limited to suction, and various known measures including electrostatic ones are also usable.

If necessary, the reference guide 102 may have an ink sump in the form of a groove which is formed corresponding to the width of the sheet of recording paper A in order to prevent contamination by ink during the making of a so-called frameless print having an image recorded over its entire surface.

It should be noted that images are not recorded exclusively in an ink-jet manner in the image forming apparatus according to the present invention, and various known methods of image recording are also usable. Examples of such methods include a method in which a photosensitive material for silver halide photography used as recording paper is exposed imagewise to recording light such as a light beam so as to record a latent image thereon, and then subjected to wet processing; a method of recording images in an electrophotographic manner; a method of recording images by thermal recording; and a method in which a photosensitive, heat-developing recording material used as recording paper is exposed imagewise to recording light such as a light beam so as to record a latent image thereon, and then subjected to heat development.

The sheet of recording paper A bearing the image recorded (print) is transported by the transporting system 92 on the downstream side to the discharging section 20. Above the transporting system 92, or between the transporting system 92 and the discharging section 20, a means for causing ink to dry such as a heater or fan may be provided.

The discharging section 20 is a conventional sorter which includes an endless belt 104 and a large number of bins 106 secured to the endless belt 104 along its circumference. Each time the prints for one order have been discharged, the endless belt 104 is rotated as predetermined in magnitude to replace the bin containing the discharged prints by a vacant one, so that prints are collected as being sorted by orders.

The image forming apparatus according to the present invention is herein described in detail, although the present invention is in no way limited to the above description. Various modifications or improvements thereof are readily possible within the scope of the invention.

What is claimed is:

1. An image forming apparatus, comprising:
a loading section for loading a recording medium;
an image recording section for recording an image on said recording medium; and
a transporting system for transporting the recording medium to said image recording section,
wherein said loading section is provided with a cassette holder block for holding a bottom of a cassette containing the recording medium in a form of a pile of cut sheets, and a magazine receiver formed in said cassette holder block as a recess in which a magazine containing the recording medium in a form of a roll of continuous recording medium is to be inserted.

2. The image forming apparatus according to claim 1, wherein said loading section has a detection device for determining whether said cassette or said magazine is loaded, and a control unit for controlling recording medium delivery in accordance with a detection result obtained by said detection device.

3. The image forming apparatus according to claim 1,
wherein said roll of the continuous recording medium is contained in said magazine as being accompanied by disc-shaped members on both sides in a direction in which a roll shaft of said roll extends,
wherein said loading section has:
a rotary shaft provided above said cassette holder block;
a sheet delivering roller which abuts an uppermost sheet of the recording medium in the form of the pile of cut sheets in said cassette and is mounted on said rotary shaft; and
disc rotating rollers which rotate said disc-shaped members in said magazine and are mounted on said rotary shaft at both sides of said sheet delivering roller, and
wherein, when said cassette is loaded in said loading section, a sheet of the recording medium in a form of cut sheet is delivered from said cassette by said sheet delivering roller, and when said magazine is loaded in said loading section, the continuous recording medium in the form of the roll is delivered from said magazine by rotating said roll of the continuous recording medium by means of said disc rotating rollers.

4. The image forming apparatus according to claim 1, wherein said loading section has:
a cut-paper delivery unit for delivering a sheet of the recording medium in a form of cut sheet from said cassette;
a rolled-paper delivery unit for delivering the continuous recording medium in the form of the roll from said magazine;
a driving source for driving said cut-paper delivery unit and said rolled-paper delivery unit;
a first transmission unit which includes a first clutch and transmits driving force of said driving source to said cut-paper delivery unit; and
a second transmission unit which includes a second clutch and transmits the driving force of said driving source to said rolled-paper delivery unit.

5. The image forming apparatus according to claim 1, wherein said cassette holder block has an extendable mechanism, and said cassette holder block is extendable in a direction in which a roll shaft of the roll of the continuous recording medium loaded in said loading section extends so that said cassette holder block and said magazine receiver are variable in size in said direction in which said roll shaft extends.

6. The image forming apparatus according to claim 1, further comprising: a regulation member for regulating said cassette held by said cassette holder block in position, with said regulation member being variable in position in itself.

7. The image forming apparatus according to claim 1,
wherein said roll of the continuous recording medium is contained in said magazine as being accompanied by disc-shaped members on both sides in a direction in which a roll shaft of said roll extends,
wherein said loading section has:
a rotary shaft provided above said cassette holder block; and
plural pairs of disc rotating rollers mounted on said rotary shaft, each pair of disc rotating rollers rotating a pair of said disc-shaped members corresponding to each of plural rolls of the continuous recording medium with different widths in said magazine, and
wherein the continuous recording medium in the form of the roll is delivered from said magazine by rotating the roll of the continuous recording medium by means of corresponding pair of said disc rotating rollers.
